(19) United States
(12) Patent Application Publication
(10) Pub. No.: US 2026/0205851 A1
(43) Pub. Date: Jul. 16, 2026

(54) COMMUNICATION METHOD, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/135,493

(22) PCT Filed: Dec. 5, 2022
(86) PCT No.: PCT/CN2022/136605

§ 371 Date: Jun. 4, 2025

(51) Int. Cl. H04W 24/10; H04W 84/12

(52) U.S. Cl. CPC H04W 24/10; H04W 84/12

(57) ABSTRACT

Embodiments of the present disclosure relate to the technical field of mobile communications, and provide a communication method, an electronic device, and a storage medium. The communication method is applied to a sensing initiator. The method comprises: determining that all sensing measurement reports from a sensing responder fail to be received, and sending a first null data packet announcement (NDPA) frame, wherein the first NDPA frame instructs the sensing responder to perform sensing measurement again and feed back the sensing measurement reports. The embodiments of the present disclosure provide an interaction mechanism for a sensing measurement result.

### CROSS REFERENCE TO RELATED APPLICATIONS

This application is a US National Phase of a PCT Application No. PCT/CN2022/136605 filed on Dec. 5, 2022, the entire contents of which are incorporated herein by reference in their entireties.

### TECHNICAL FIELD

The embodiments of the present disclosure relate to the field of mobile communication technology, in particular to communication methods, electronic devices, and storage media.

### BACKGROUND

In currently researched Wi-Fi technologies, Wireless Local Area Network (WLAN) sensing technology may be supported. For example, application scenarios of WLAN sensing technology include location discovery, proximity detection, and presence detection in dense environments (e.g., home environment and enterprise environment).

In the process of WLAN Sensing, the sensing responder needs to transmit a sensing measurement result to the sensing initiator. Therefore, it is necessary to provide an interactive mechanism for the sensing measurement result to support WLAN Sensing.

### SUMMARY

The embodiments of the present disclosure provide communication methods, electronic devices, and storage media for providing an interactive mechanism for sensing measurement results.

On the one hand, the embodiments of the present disclosure provide a communication method performed by a sensing initiator, including:

determining that not all of sensing measurement reports from a sensing responder are received; and transmitting a first Null Data Packet Announcement (NDPA) frame, where the first NDPA frame indicates the sensing responder to perform a sensing measurement again and feedback a sensing measurement report.

On the other hand, the embodiments of the present disclosure further provide a communication method performed by a sensing responder, including:

receiving a first Null Data Packet Announcement (NDPA) frame, where the first NDPA frame identifies that a sensing initiator does not receive all of sensing measurement reports, and the first NDPA frame indicates the sensing responder to perform a sensing measurement again and feedback a sensing measurement report.

On the other hand, the embodiments of the present disclosure further provide an electronic device, which is a sensing initiator, including:

a determining module, configured to determine that not all of sensing measurement reports from a sensing responder are received; and transmit a first Null Data Packet Announcement (NDPA) frame, where the first NDPA frame indicates the sensing responder to perform a sensing measurement again and feedback a sensing measurement report.

On the other hand, the embodiments of the present disclosure further provide an electronic device, which is a sensing responder, including:

a receiving module, configured to receive a first Null Data Packet Announcement (NDPA) frame, where the first NDPA frame identifies that a sensing initiator does not receive all of sensing measurement reports, and the first NDPA frame indicates the sensing responder to perform a sensing measurement again and feedback a sensing measurement report.

The embodiments of the present disclosure further provide an electronic device including a memory, a processor, and a computer program stored in the memory and executable on the processor. The processor executes the program, to implement the method described in one or more of the embodiments of the present disclosure.

The embodiments of the present disclosure further provide a computer-readable storage medium in which a computer program is stored. The computer program is executed by a processor, to implement the method described in one or more of the embodiments of the present disclosure.

In the embodiments of the present disclosure, the sensing initiator determines that not all sensing measurement reports from the sensing responder are received, and transmits a first Null Data Packet Announcement (NDPA) frame, where the first NDPA frame indicates the sensing responder to perform a sensing measurement again and feedback a sensing measurement report, to ensure that all sensing measurement results are received and improve the accuracy of the sensing measurement results. The embodiments of the present disclosure provide an interactive mechanism for sensing measurement results.

The additional aspects and advantages of the embodiments of the present disclosure will be partially presented in the following description, which will become apparent from the following description or learned through practice of the present disclosure.

### BRIEF DESCRIPTION OF DRAWINGS

In order to more clearly illustrate the technical solutions according to the embodiments of the present disclosure, drawings that need to be used in the description of the embodiments will be briefly introduced below. The drawings in the following description only relate to some embodiments of the present disclosure. For those skilled in the art, other drawings can also be obtained according to these drawings without creative effort.

FIG. 1 is the first flowchart of a communication method provided in the embodiments of the present disclosure.

FIG. 2 is the first schematic diagram of the first example of the embodiments of the present disclosure.

FIG. 3 is the second schematic diagram of the first example of the embodiments of the present disclosure.

FIG. 4 is the third schematic diagram of the first example of the embodiments of the present disclosure.

FIG. 5 is the second flowchart of the communication method provided in the embodiments of the present disclosure.

FIG. 6 is the first schematic structural diagram of an electronic device provided in the embodiments of the present disclosure.

FIG. 7 is the second schematic structural diagram of an electronic device provided in the embodiments of the present disclosure.

FIG. 8 is the third schematic structural diagram of an electronic device provided in the embodiments of the present disclosure.

### DETAILED DESCRIPTION

Embodiments will be described in detail here with the examples thereof expressed in the drawings. Where the following description refers to the drawings, elements with the same numerals in different drawings refer to the same or similar elements unless otherwise indicated. Implementations described in the following embodiments do not represent all implementations consistent with the present disclosure. On the contrary, they are examples of an apparatus and a method consistent with some aspects of the present disclosure described in detail in the appended claims.

The term used in the embodiments of the present disclosure is for the purpose of describing particular examples only and is not intended to limit the present disclosure. As used in the present disclosure and the appended claims, the singular forms “a”, “an” and “the” are intended to include the plural forms as well, unless the context clearly indicates otherwise. It should further be understood that the term “and/or” as used herein refers to and includes any and all possible combinations of one or more of the associated listed items. For example, A and/or B can represent three situations of A alone, A and B simultaneously, and B alone. The character “/” generally indicates that the associated objects before and after “/” are in an “or” relationship. The term “a plurality of” refers to two or more, and therefore, in the embodiments of the present disclosure, “a plurality of” can also be understood as “at least two”.

It should be understood that although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, the word “if” as used herein can be interpreted as “at the time of”, “when” or “in response to determining”.

The technical solutions in the embodiments of the present disclosure are clearly described below with reference to the accompanying drawings in the embodiments of the present disclosure. The embodiments described are merely some embodiments of the present disclosure, and not all embodiments. Other embodiments achieved by those skilled in the art according to the embodiments in the present disclosure without paying creative work shall all fall within the scope of protection of the present disclosure.

The embodiments of the present disclosure provide communication methods, electronic devices, and storage media for providing an interactive mechanism for sensing measurement results.

Where the methods and apparatuses are based on the same application concept. Since the problem-solving principles of the methods and apparatuses are similar, the implementation of the apparatuses and the implementation of methods can be referred to each other, which will not be repeated.

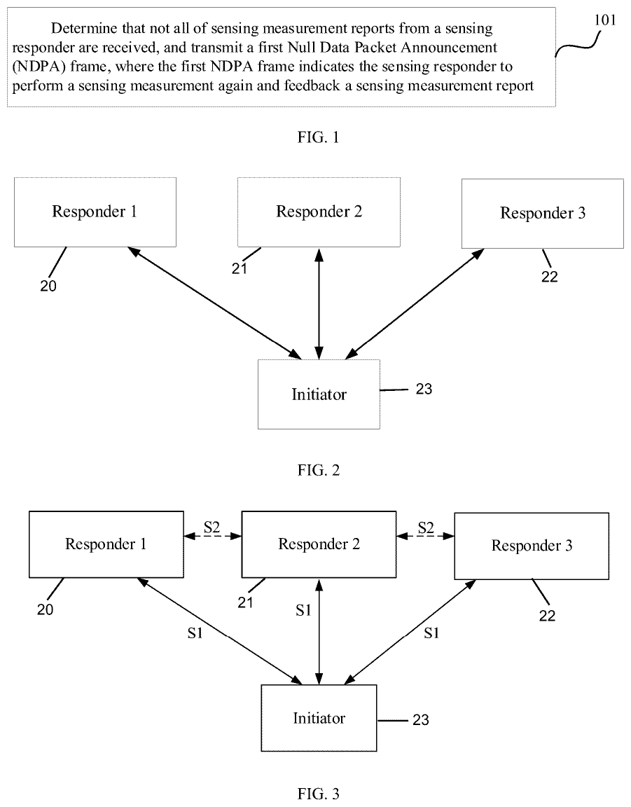

As shown in FIG. 1, the embodiments of the present disclosure provide a communication method. The method can be optionally performed by a sensing initiator, such as an SBP (Sensing By Proxy) initiator. The method may include the following step 101.

In step 101, that not all of sensing measurement reports from a sensing responder are received is determined, and a first Null Data Packet Announcement (NDPA) frame is transmitted, where the first NDPA frame indicates the sensing responder to perform a sensing measurement again and feedback a sensing measurement report.

As a first example, referring to FIGS. 2 to 4, the architecture and process of WLAN Sensing applied in the communication method provided in the embodiments of the present disclosure are first introduced.

FIG. 2 shows a schematic diagram of the architecture of WLAN Sensing (process). When the sensing initiator (or initiator) 23 initiates WLAN sensing (such as initiating a WLAN sensing session), there may be multiple sensing responders or sensing receivers (such as responders 1, 2, and 3 shown as 20, 21, 22 in FIG. 2) responding to the WLAN sensing. When the sensing initiator initiates WLAN Sensing, multiple associated or non-associated sensing responders for the WLAN Sensing can respond.

Referring to FIG. 3, the sensing initiator 23 and the sensing responder 20, 21, 22 communicate through a communication connection, such as the communication connection S1 as shown, and the sensing responders communicate with each other through the communication connection S2.

Where each sensing initiator can be a client, and each sensing responder (in this example, sensing responder 1 to sensing responder 3) can be a station (STA) or an access point (AP). In addition, STA and AP can play multiple roles in WLAN sensing process. For example, in the WLAN sensing process, STA can also act as the sensing initiator, where the sensing initiator may be a sensing transmitter, a sensing receiver, or both, or neither. In the WLAN sensing process, the sensing responder may also be the sensing transmitter, the sensing receiver, or both.

In the embodiments of the present disclosure, the AP, such as a device with wireless to wired bridging function, is responsible for extending the services provided by the wired network to the wireless network. The Station (STA), such as an electronic device with wireless network access function, provides frame delivery services to facilitate the transmission of information.

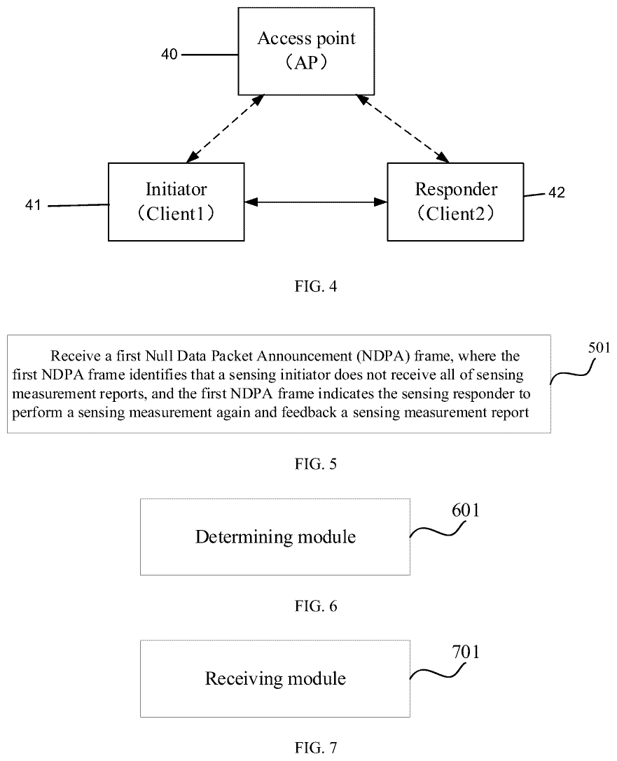

As another architecture, as shown in FIG. 4, the sensing initiator 41 and sensing responder 42 can both be clients, and they can communicate by connecting to the same access point (AP) 40. In FIG. 4, Client 1 is the sensing initiator, and Client 2 is the sensing responder.

Usually, the WLAN sensing process includes a Trigger Based (TB) sensing approach and a Non-TB sensing approach. Specifically, the TB sensing measurement approach refers to AP as the initiator or the transmitter, and the Non-TB sensing measurement approach refers to STA as the initiator or the transmitter.

Furthermore, the SBP responder acts as the proxy for SBP to initiate WLAN sensing measurement, where the initiated WLAN sensing measurement is the TB sensing measurement. The TB sensing measurement is divided into an NDPA Sounding (downlink, DL) process and a trigger frame Sounding (uplink, UL) process.

During the sensing measurement setup, if the sensing initiator requires the sensing responder to feedback the sensing measurement results, the sensing initiator identifies that the sensing responder is required to feedback the measurement results. Optionally, in both Triggered Based (TB) and Non-TB based (NTB) sensing measurement approaches, the sensing measurement results can be fed back through sensing measurement report frame(s). In Sensing By Proxy (SBP), the SBP responder can feedback sensing measurement results to the SBP initiator through SBP report frame(s).

Normally, both the sensing measurement report frame and the SBP report frame are No ACK action frames. That is, the sensing initiator (SBP initiator) will not feedback ACK frames to the sensing responder (SBP responder). Therefore, the sensing responder, after transmitting the sensing measurement result frame, does not cache the sensing measurement result frame, and usually immediately discards the sensing measurement result frame. However, in the actual sensing measurement process, there may be situations where a certain sensing measurement result frame cannot be received correctly, which may result in sensing measurement results being inaccurate. Taking the TB sensing measurement approach as an example, all or part of the sensing measurement reports from the sensing responder have not been received, that is, all sensing measurement report frames from all sensing responders have not been fully received. For example, all or part of the sensing measurement result frames fed back from a certain sensing responder have not been correctly received, or all or part of the sensing measurement result frames fed back from multiple sensing responders have not been correctly received.

To ensure the accuracy of the sensing measurement results, the sensing initiator transmits the first Null Data Packet Announcement (NDPA) frame when determining that all sensing measurement reports from the sensing responder have not been received, where the first NDPA frame instructs the sensing responder to perform the sensing measurement again and feedback the sensing measurement report until the sensing initiator receives all sensing measurement reports, to avoid missing sensing measurement result frames which results in the sensing measurement results being inaccurate.

In the embodiments of the present disclosure, the sensing initiator determines that not all sensing measurement reports from the sensing responder are received, and transmits a first Null Data Packet Announcement (NDPA) frame, where the first NDPA frame indicates the sensing responder to perform a sensing measurement again and feedback a sensing measurement report, to ensure that all sensing measurement results are received and improve the accuracy of the sensing measurement results. The embodiments of the present disclosure provide an interactive mechanism for sensing measurement results.

The embodiments of the present disclosure provide a communication method, which can be optionally performed by a sensing initiator. The method may include the following steps:

determining that not all sensing measurement reports from the sensing responder are received, and transmitting a first Null Data Packet Announcement (NDPA) frame, where the first NDPA frame indicates the sensing responder to perform a sensing measurement again and feedback a sensing measurement report, where the first NDPA frame includes a measurement setup identifier (MSID) and sensing parameter information.

The MSID includes the MSID corresponding to a target Measurement Setup (MS) where all or part of the sensing measurement reports have not been received, that is, the MSID refers to the MSID corresponding to the MS where the sensing measurement reports have not been fully received by the sensing initiator. In the case of NTB, it is possible that the report frame corresponding to the measurement instance ID included in a certain MSID is not received. The sensing parameter information includes the sensing parameter information of the target MS, such as bandwidth information (BW), spatial stream information (SS), etc, which is consistent with that during the target MS.

The embodiments of the present disclosure provide a communication method, which can be optionally performed by a sensing initiator. The method may include the following steps:

determining that not all sensing measurement reports from the sensing responder are received, and transmitting a first Null Data Packet Announcement (NDPA) frame, where the first NDPA frame indicates the sensing responder to perform a sensing measurement again and feedback a sensing measurement report, where the first NDPA frame includes a measurement setup identifier (MSID) and sensing parameter information; where a common info field of the NDPA frame includes first identifier information to identify the NDPA frame for re-sensing measurement.

The MSID includes the MSID corresponding to the target Measurement Setup (MS) where not all of the sensing measurement reports have been received, and the sensing parameter information includes the sensing parameter information of the target MS. The first NDPA frame includes first identifier information indicating that the first NDPA frame is configured to initiate a sensing measurement again.

Optionally, in the embodiments of the present disclosure, the sensing parameter information includes measurement setup expiry exponent information.

When a time for initiating the sensing measurement again exceeding time information in the measurement setup expiry exponent information, the sensing responder is indicated to no longer perform the sensing measurement.

As a second example, the format of the sensing parameter information is shown in Table 1 below:

TABLE 1

| | | | Sensing | Sensing | Measurement | |
|---|---|---|---|---|---|---|
| | | | Measurement | Measurement | setup | |
| | Sensing | Sensing | Report | Report | expiry | |
| Content | transmitter | Receiver | Requested | Type | exponent | TBD |
| Bits | 1 | 1 | 1 | 3 | 4 | TBD |

Where the sensing parameter information includes the measurement setup expiry exponent. If the time point when the re-sensing measurement starts exceeds the measurement setup expiry exponent time established during the sensing measurement process, the sensing measurement process will not occur again.

The embodiments of the present disclosure provide a communication method, which can be optionally performed by a sensing initiator. The method may include the following steps:
transmitting a first radio frame indicating the sensing responder to transmit sensing measurement reports, where the first radio frame, such as the sensing measurement report trigger frame in the TB sensing measurement or the measurement setup (MS) report request frame in the SBP process, is configured to indicate the sensing responder to transmit the sensing measurement reports; and
determining that not all sensing measurement reports from the sensing responder are received; and transmitting a first Null Data Packet Announcement (NDPA) frame, where the first NDPA frame indicates the sensing responder to perform a sensing measurement again and feedback a sensing measurement report.

The embodiments of the present disclosure provide a communication method, which can be optionally performed by a sensing initiator. The method may include the following steps:
in the TB sensing measurement, transmitting a sensing measurement report trigger frame, where the sensing measurement report trigger frame indicates the sensing responder to transmit sensing measurement reports; and
determining that not all sensing measurement reports from the sensing responder are received; and transmitting a first Null Data Packet Announcement (NDPA) frame, where the first NDPA frame indicates the sensing responder to perform a sensing measurement again and feedback a sensing measurement report.

During the TB sensing measurement process, the sensing initiator transmits a sensing measurement report trigger frame, where the sensing measurement report trigger frame indicates the sensing responder to transmit the sensing measurement report. If the sensing initiator has not received all or part of the sensing measurement reports from the sensing responder, that is, all sensing measurement report frames from all sensing responders have not been fully received. For example, all or part of the sensing measurement result frames fed back from a certain sensing responder have not been correctly received, or all or part of the sensing measurement result frames fed back from multiple sensing responders have not been correctly received.

The embodiments of the present disclosure provide a communication method, which can be optionally performed by a sensing initiator. The method may include the following steps:
in sensing by proxy (SBP), transmitting a measurement setup (MS) report request frame, where the MS report request frame indicates the sensing responder to transmit a sensing measurement report; and
determining that not all sensing measurement reports from the sensing responder are received; and transmitting a first Null Data Packet Announcement (NDPA) frame, where the first NDPA frame indicates the sensing responder to perform a sensing measurement again and feedback a sensing measurement report.

In SBP sensing measurement, the sensing initiator transmits an MS report request frame to instruct the sensing responder to transmit the sensing measurement report. The MS report request frame includes MSID and measurement instance ID. The MS report request frame can also include a flag identifying that the SBP initiator has not received the SBP report and that the SBP responder needs to perform a sensing measurement again.

The embodiments of the present disclosure provide a communication method, which can be optionally performed by a sensing initiator. The method may include the following steps:
in sensing by proxy (SBP), transmitting a measurement setup (MS) report request frame, where the MS report request frame indicates the sensing responder to transmit a sensing measurement report;
determining that not all sensing measurement reports from one or more sensing responders are received; and transmitting a first Null Data Packet Announcement (NDPA) frame, where the first NDPA frame indicates the one or more sensing responders to perform sensing measurements again and feedback sensing measurement reports; and
determining that not all of the sensing measurement reports have been received when not receiving some or all of the sensing measurement reports from the one or more sensing responders.

If the sensing initiator has not received all or part of the sensing measurement reports from the sensing responders, that is, all sensing measurement report frames from all sensing responders have not been fully received. For example, all or part of the sensing measurement result frames fed back from a certain sensing responder have not been correctly received, or all or part of the sensing measurement result frames fed back from multiple sensing responders have not been correctly received.

The embodiments of the present disclosure provide a communication method, which can be optionally performed by a sensing initiator. The method may include the following steps:

determining that all sensing measurement reports from the sensing responder have not been received, where in NTB sensing measurement, if the manner for feedbacking the sensing measurement report is immediate feedback, the STA acting as the sensing initiator will transmit the first NDPA frame once, where the first NDPA frame indicates the sensing responder to perform a sensing measurement again and feedback a sensing measurement report.

If the manner for feedbacking the sensing measurement report is delayed feedback, the STA acting as the sensing initiator transmits the first NDPA frame twice, that is, after the first NDPA frame is transmitted twice consecutively, the sensing responder will feedback the sensing measurement report.

The embodiments of the present disclosure provide a communication method, which can be optionally performed by a sensing initiator. The method may include the following steps:
in sensing by proxy (SBP), transmitting a measurement setup (MS) report request frame within the SBP ISTA (Initiator Station) availability window, where the MS report request frame includes the MSID corresponding to the target MS for which not all of the sensing measurement reports have been received and the measurement event identifier (ID) of the target MS, where the MSID refers to the MSID corresponding to the MS where sensing measurement reports have not been fully received by the sensing initiator; and
determining that not all sensing measurement reports from the sensing responder are received; and transmitting a first Null Data Packet Announcement (NDPA) frame, where the first NDPA frame indicates the sensing responder to perform a sensing measurement again and provide a sensing measurement report, where the sensing responder includes the sensing responder corresponding to the MSID.

In an optional embodiment, the MS report request frame includes second identifier information indicating that an SBP initiator does not receive an SBP measurement report. The MS report request frame further includes a second identifier information, identifying that the SBP initiator has not received the SBP report and that the SBP responder needs to perform a sensing measurement again.

In the embodiments of the present disclosure, the sensing initiator determines that not all sensing measurement reports from the sensing responder are received, and transmits a first Null Data Packet Announcement (NDPA) frame, where the first NDPA frame indicates the sensing responder to perform a sensing measurement again and feedback a sensing measurement report, to ensure that all sensing measurement results are received and improve the accuracy of the sensing measurement results. The embodiments of the present disclosure provide an interactive mechanism for sensing measurement results.

Referring to FIG. 5, the embodiments of the present disclosure provide a communication method, which can be optionally performed by a sensing responder. The method may include the following step 501.

In step 501, a first Null Data Packet Announcement (NDPA) frame is received, where the first NDPA frame identifies that a sensing initiator does not receive all of sensing measurement reports, and the first NDPA frame indicates the sensing responder to perform a sensing measurement again and feedback a sensing measurement report.

Where the architecture and process of WLAN Sensing applied in the communication method provided in the embodiments of the present disclosure refer to the first example mentioned above and will not be repeated here.

Usually, the WLAN sensing process includes Trigger Based (TB) sensing approach and Non-TB sensing approach. Specifically, the TB sensing measurement approach refers to AP as the initiator or the transmitter, and the Non-TB sensing measurement approach refers to STA as the initiator or the transmitter.

Furthermore, the SBP responder acts as the proxy for SBP to initiate WLAN sensing measurement, where the initiated WLAN sensing measurement is the TB sensing measurement. The TB sensing measurement is divided into an NDPA Sounding (downlink, DL) process and a trigger frame Sounding (uplink, UL) process.

During the sensing measurement setup, if the sensing initiator requires the sensing responder to feedback the sensing measurement results, the sensing initiator marks that the sensing responder is required to feedback the measurement results. Optionally, in both Triggered Based (TB) and Non-TB based (NTB) sensing measurement approaches, the sensing measurement results can be fed back through a sensing measurement report frame. In Sensing By Proxy (SBP), the SBP responder can provide sensing measurement results to the SBP initiator through an SBP report frame.

Normally, both the sensing measurement report frame and the SBP report frame are No ACK action frames. That is, the sensing initiator (SBP initiator) will not feedback ACK frames to the sensing responder (SBP responder). Therefore, the sensing responder, after transmitting the sensing measurement result frame, does not cache the sensing measurement result frame, and usually immediately discards the sensing measurement result frame. However, in the actual sensing measurement process, there may be situations where a certain sensing measurement result frame cannot be received correctly, which may result in sensing measurement results being inaccurate. Taking the TB sensing measurement approach as an example, all or part of the sensing measurement reports from the sensing responder have not been received, that is, all sensing measurement report frames from all sensing responders have not been fully received. For example, all or part of the sensing measurement result frames fed back from a certain sensing responder have not been correctly received, or, all or part of the sensing measurement result frames fed back from multiple sensing responders have not been correctly received. Taking the NTB sensing measurement process as an example, when not all sensing measurement reports from the sensing responder have been received, the report frame corresponding to the measurement instance ID contained in a certain MSID may not be received.

To ensure the accuracy of sensing measurement results, the sensing responder receives NDPA frames. The first NDPA frame instructs the sensing responder to perform sensing measurement again and provide sensing measurement reports until the sensing initiator receives all sensing measurement reports, to avoid missing sensing measurement result frames which results in the sensing measurement results being inaccurate.

In the embodiments of the present disclosure, the sensing responder receives NDPA frames. The first NDPA frame instructs the sensing responder to perform a sensing measurement again and feedback a sensing measurement report to ensure that the sensing initiator receives all sensing measurement results and improves the accuracy of the sensing measurement results. The embodiments of the present disclosure provide an interactive mechanism for sensing measurement results.

The embodiments of the present disclosure provide a communication method, which can be optionally performed by the sensing responder. The method may include the following steps:

receiving the Null Data Packet Announcement (NDPA) frame, where the first NDPA frame includes a measurement setup identifier (MSID) and sensing parameter information.

The MSID includes the MSID corresponding to a target Measurement Setup (MS) where all or part of the sensing measurement reports have not been received, that is, the MSID refers to the MSID corresponding to the MS where the sensing measurement reports have not been fully received by the sensing initiator; and the sensing parameter information includes the sensing parameter information of the target MS, such as bandwidth information (BW), spatial stream information (SS), etc, which is consistent with that during the target MS.

Where the first NDPA frame identifies that a sensing initiator does not receive all of sensing measurement reports, and the first NDPA frame indicates the sensing responder to perform a sensing measurement again and feedback a sensing measurement report.

The embodiments of the present disclosure provide a communication method, which can be optionally performed by the sensing responder. The method may include the following steps:

receiving the Null Data Packet Announcement (NDPA) frame, where the first NDPA frame includes a measurement setup identifier (MSID) and sensing parameter information, and the first NDPA frame includes first identifier information indicating that the first NDPA frame is configured to initiate a sensing measurement again. A common info field of the NDPA frame can include first identifier information to identify the NDPA frame for re-sensing measurement.

The MSID includes an MSID corresponding to a target Measurement Setup (MS) for which not all of the sensing measurement reports are received, and the sensing parameter information includes sensing parameter information of the target MS.

Where the first NDPA frame identifies that a sensing initiator does not receive all of sensing measurement reports, and the first NDPA frame indicates the sensing responder to perform a sensing measurement again and feedback a sensing measurement report.

Optionally, the sensing parameter information includes measurement setup expiry exponent information.

When a time for initiating the sensing measurement again exceeding time information in the measurement setup expiry exponent information, the sensing responder is indicated to no longer perform the sensing measurement.

Where the format of the sensing parameter information refers to Table 1 mentioned above. the sensing parameter information includes the measurement setup expiry exponent. If the time point when the re-sensing measurement starts exceeds the measurement setup expiry exponent time established during the sensing measurement process, the sensing measurement process will not occur again.

The embodiments of the present disclosure provide a communication method, which can be optionally performed by the sensing responder. The method may include the following steps:
receiving a first radio frame indicating the sensing responder to transmit a sensing measurement report, where the first radio frame, such as the sensing measurement report trigger frame in TB sensing measurement or the measurement setup (MS) report request frame in SBP process, is configured to indicate the sensing responder to transmit the sensing measurement report; and
receiving a first Null Data Packet Announcement (NDPA) frame, where the first NDPA frame identifies that a sensing initiator does not receive all of sensing measurement reports, and the first NDPA frame indicates the sensing responder to perform a sensing measurement again and feedback a sensing measurement report.

The embodiments of the present disclosure provide a communication method, which can be optionally performed by the sensing responder. The method may include the following steps:
in the TB sensing measurement, receiving a sensing measurement report trigger frame, where the sensing measurement report trigger frame indicates the sensing responder to receive the sensing measurement report; and
receiving a first Null Data Packet Announcement (NDPA) frame, where the first NDPA frame identifies that a sensing initiator does not receive all of sensing measurement reports, and the first NDPA frame indicates the sensing responder to perform a sensing measurement again and feedback a sensing measurement report.

During the TB sensing measurement process, the sensing initiator transmits a sensing measurement report trigger frame, where the sensing measurement report trigger frame indicates the sensing responder to transmit the sensing measurement report. If the sensing initiator has not received all or part of the sensing measurement reports from the sensing responder, that is, all sensing measurement report frames from all sensing responders have not been fully received. For example, all or part of the sensing measurement result frames fed back from a certain sensing responder have not been correctly received, or, all or part of the sensing measurement result frames fed back from multiple sensing responders have not been correctly received.

The embodiments of the present disclosure provide a communication method, which can be optionally performed by the sensing responder. The method may include the following steps:
in sensing by proxy (SBP), receiving a measurement setup (MS) report request frame, where the MS report request frame indicates the sensing responder to transmit a sensing measurement report;
receiving a first Null Data Packet Announcement (NDPA) frame, where the first NDPA frame identifies that a sensing initiator does not receive all of sensing measurement reports, and the first NDPA frame indicates the sensing responder to perform a sensing measurement again and feedback a sensing measurement report.

In SBP sensing measurement, the sensing initiator transmits an MS report request frame to instruct the sensing responder to transmit the sensing measurement report. The MS report request frame includes MSID and measurement instance ID. The MS report request frame can also include a flag identifying that the SBP initiator has not received the SBP report and that the SBP responder needs to perform sensing measurements again.

The embodiments of the present disclosure provide a communication method, which can be optionally performed by the sensing responder. The method may include the following steps:
in sensing by proxy (SBP), receiving a measurement setup (MS) report request frame within the SBP ISTA (Initiator Station) availability window, where the MS report request frame includes the MSID corresponding to the target MS for which not all of the sensing measurement reports have been received and the measurement event ID of the target MS, where the MSID refers to the MSID corresponding to the MS where sensing measurement reports have not been fully received by the sensing initiator, where the MS report request frame indicates the sensing responder to transmit the sensing measurement report; and
receiving a first Null Data Packet Announcement (NDPA) frame, where the first NDPA frame identifies that a sensing initiator does not receive all of sensing measurement reports, and the first NDPA frame indicates the sensing responder to perform a sensing measurement again and feedback a sensing measurement report.

Optionally, the MS report request frame includes second identifier information indicating that the SBP initiator has not received the SBP measurement report. The MS report request frame further includes a second identifier information, identifying that the SBP initiator has not received the SBP report and that the SBP responder needs to perform sensing measurements again.

The embodiments of the present disclosure provide a communication method, which can be optionally performed by the sensing responder. The method may include the following steps:
in a non-trigger-based (NTB) sensing measurement, when a manner for feedbacking the sensing measurement reports is immediate feedback, receiving the first NDPA frame once;
when the manner for feedbacking the sensing measurement report is delayed feedback, receiving the first NDPA frame twice; where the first NDPA frame indicates that the sensing initiator has not received all of the sensing measurement reports, and the first NDPA frame instructs the sensing responder to perform a sensing measurement again and feedback the sensing measurement report, that is, the sensing responder only provides the sensing measurement report after the first NDPA frame is transmitted twice consecutively.

In the embodiments of the present disclosure, the sensing responder receives NDPA frames. The first NDPA frame instructs the sensing responder to perform a sensing measurement again and feedback the sensing measurement report to ensure that the sensing initiator receives all sensing measurement results and improves the accuracy of the sensing measurement results. The embodiments of the present disclosure provide an interactive mechanism for sensing measurement results.

Referring to FIG. 6, based on the same principle as the method provided in the embodiments of the present disclosure, the embodiments of the present disclosure further provide an electronic device, which is a sensing initiator, including:
a determining module 601, configured to determine that not all of sensing measurement reports from sensing responder are received; and transmit a first Null Data Packet Announcement (NDPA) frame, where the first NDPA frame indicates the sensing responder to perform a sensing measurement again and feedback a sensing measurement report.

In an optional embodiment, the determining module 601 is configured to:
transmitting the Null Data Packet Announcement (NDPA) frame, where the first NDPA frame includes a measurement setup identifier (MSID) and sensing parameter information, and
the MSID includes an MSID corresponding to a target Measurement Setup (MS) for which not all of the sensing measurement reports are received, and the sensing parameter information includes sensing parameter information of the target MS.

In an optional embodiment, the first NDPA frame includes first identifier information indicating that the first NDPA frame is configured to initiate a sensing measurement again.

In an optional embodiment, the sensing parameter information includes measurement setup expiry exponent information.

When a time for initiating the sensing measurement again exceeding time information in the measurement setup expiry exponent information, the sensing responder is indicated to no longer perform the sensing measurement.

In an optional embodiment, the electronic device includes:
the transmitting module, configured to transmit a first radio frame indicating the sensing responder to transmit sensing measurement reports.

In an optional embodiment, the transmitting module is configured to:
in trigger-based (TB) sensing measurement, transmit a sensing measurement report trigger frame;
or
in sensing by proxy (SBP), transmit a measurement setup (MS) report request frame.

In an optional embodiment, the determining module 601 is configured to:
in response to not receiving a part or all of the sensing measurement reports from one or more sensing responders, determine that not all of the sensing measurement reports are received.

In an optional embodiment, the determining module 601 is configured to:
in a non-trigger-based (NTB) sensing measurement, when a manner for feedbacking the sensing measurement reports is immediate feedback, transmit the first NDPA frame once;
when a manner for feedbacking the sensing measurement reports is delayed feedback, transmit the first NDPA frame twice.

In an optional embodiment, the transmitting module is configured to:

in the sensing by proxy (SBP), transmit the measurement setup (MS) report request frame within an SBP ISTA (Initiator Station) availability window, where the MS report request frame includes an MSID corresponding to a target MS for which not all of the sensing measurement reports are received and a measurement event ID of the target MS.

In an optional embodiment, the MS report request frame includes second identifier information indicating that an SBP initiator does not receive an SBP measurement report.

The embodiments of the present disclosure further provide a communication apparatus, applied to a sensing initiator, including:

a NDPA frame determining module, configured to determine that not all of sensing measurement reports from sensing responder are received; and transmit a first Null Data Packet Announcement (NDPA) frame, where the first NDPA frame indicates the sensing responder to perform a sensing measurement again and feedback a sensing measurement report.

The apparatus further includes other modules of the electronic device in the previous embodiments, which will not be repeated here.

Referring to FIG. 7, based on the same principle as the method provided in the embodiments of the present disclosure, the embodiments of the present disclosure further provide an electronic device, which is a sensing initiator, including:

a receiving module 701, configured to receive a first Null Data Packet Announcement (NDPA) frame, where the first NDPA frame identifies that a sensing initiator does not receive all of sensing measurement reports, and the first NDPA frame indicates the sensing responder to perform a sensing measurement again and feedback a sensing measurement report.

In an optional embodiment, the receiving module 701 is configured to:

receive the Null Data Packet Announcement (NDPA) frame, where the first NDPA frame includes a measurement setup identifier (MSID) and sensing parameter information, and

the MSID includes an MSID corresponding to a target Measurement Setup (MS) for which not all of the sensing measurement reports are received, and the sensing parameter information includes sensing parameter information of the target MS.

In an optional embodiment, the first NDPA frame includes first identifier information indicating that the first NDPA frame is configured to initiate a sensing measurement again.

In an optional embodiment, the sensing parameter information includes measurement setup expiry exponent information.

When a time for initiating the sensing measurement again exceeding time information in the measurement setup expiry exponent information, the sensing responder is indicated to no longer perform the sensing measurement.

In an optional embodiment, the electronic device includes:
a radio frame receiving module, configured to receive a first radio frame indicating the sensing responder to receive the sensing measurement reports.

In an optional embodiment, the radio frame receiving module is configured for:
in trigger-based (TB) sensing measurement, receiving a sensing measurement report trigger frame;
or
in sensing by proxy (SBP), receiving a measurement setup (MS) report request frame.

In an optional embodiment, the radio frame receiving module is configured for:

in the sensing by proxy (SBP), receiving the measurement setup (MS) report request frame within an SBP ISTA (Initiator Station) availability window, where the MS report request frame includes an MSID corresponding to a target MS for which not all of the sensing measurement reports are received and a measurement event ID of the target MS.

In an optional embodiment, the MS report request frame includes second identifier information indicating that an SBP initiator does not receive an SBP measurement report.

In an optional embodiment, the receiving module 701 is configured for:
in a non-trigger-based (NTB) sensing measurement, when a manner for feedbacking the sensing measurement reports is immediate feedback, receiving the first NDPA frame once;
when a manner for feedbacking the sensing measurement reports is delayed feedback, receiving the first NDPA frame twice.

The embodiments of the present disclosure further provide a communication apparatus, applied to a sensing initiator, including:

a NDPA frame receiving module, configured to receive a first Null Data Packet Announcement (NDPA) frame, where the first NDPA frame identifies that a sensing initiator does not receive all of sensing measurement reports, and the first NDPA frame indicates the sensing responder to perform a sensing measurement again and feedback a sensing measurement report.

The apparatus further includes other modules of the electronic device in the previous embodiments, which will not be repeated here.

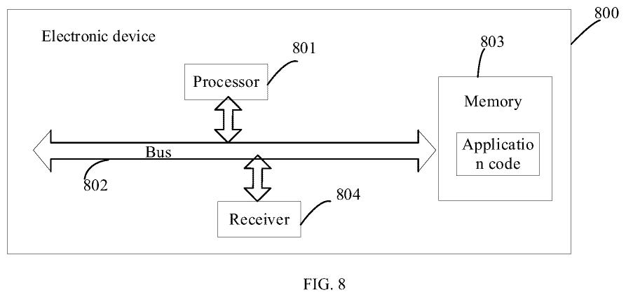

In an optional embodiment, the present disclosure further provides an electronic device, as shown in FIG. 8. The electronic device 800 shown in FIG. 8 can be a server, including a processor 801 and a memory 803. Where processor 801 is connected to memory 803, such as through bus 802. Optionally, electronic device 800 may also include a transceiver 804. It should be noted that in practical applications, the transceiver 804 is not limited to one, and the structure of the electronic device 800 does not constitute a limitation on the embodiments of the present disclosure.

The processor 801 can be a CPU (Central Processing Unit), general-purpose processor, DSP (Digital Signal Processor), ASIC (Application Specific Integrated Circuit), FPGA (Field Programmable Gate Array), or any combination thereof. It can implement or execute various exemplary logical blocks, modules, and circuits described in conjunction with the present disclosure. The processor 801 can also be a combination that implements computing functions, such as a combination containing one or more microprocessors, a combination of DSP and microprocessors, etc.

Bus 802 may include a pathway for transmitting information between the aforementioned components. Bus 802 can be a PCI (Peripheral Component Interconnect) bus or an EISA (Extended Industry Standard Architecture) bus, etc. Bus 802 can be divided into address bus, data bus, control bus, etc. For ease of representation, only one thick line is used in FIG. 8, but it does not indicate that there is only one bus or one type of bus.

The memory 803 can be a ROM (Read Only Memory) or other types of static storage devices that can store static information and instructions, or RAM (Random Access Memory) or other types of dynamic storage devices that can store information and instructions, can also be EEPROM (Electrically Erasable Programmable Read Only Memory), CD-ROM (Compact Disc Read Only Memory) or other optical disc storage, optical disc storage (including compressed optical discs, laser discs, optical discs, digital versatile discs, Blu ray discs, etc.), magnetic disk storage media or other magnetic storage devices, or any other medium that can be used to carry or store desired program code in the form of instructions or data structures and can be accessed by a computer, which is not limited.

The memory 803 is used to store the application program code for executing the disclosed scheme, and is controlled for execution by the processor 801. The processor 801 is used to execute the application program code stored in the memory 803 to implement the content shown in the aforementioned method embodiments.

Where electronic devices include but are not limited to mobile terminals such as mobile phones, laptops, digital broadcast receivers, PDAs (personal digital assistants), PADs (tablets), PMPs (portable multimedia players), car terminals (such as car navigation terminals), and fixed terminals such as digital TVs, desktop computers, and so on. The electronic device shown in FIG. 8 is only an example and should not impose any limitations on the scope of function and use of the embodiments of the present disclosure.

The servers provided in the present disclosure can be independent physical servers, server clusters or distributed systems composed of multiple physical servers, or cloud services, cloud databases, cloud computing, cloud functions, cloud storage, network services, cloud communication, middleware services, domain name services, security services, CDNs, or cloud servers for basic cloud computing services such as big data and artificial intelligence platforms. The terminal can be a smartphone, tablet, laptop, desktop computer, smart speaker, smartwatch, etc., which is not limited. Terminals and servers can be directly or indirectly connected through wired or wireless communication methods, which is not limited in the present disclosure.

The embodiments of the present disclosure provide a computer-readable storage medium on which a computer program is stored, which, when run on a computer, enables the computer to execute the corresponding content of the aforementioned method embodiments.

It should be understood that although the various steps in the flowchart of figures are displayed in sequence according to the arrows, these steps are not necessarily executed in sequence in the order indicated by the arrows. Unless otherwise specified in this article, there is no strict order limit for the execution of these steps, and they can be executed in other orders. Moreover, at least some of the steps in the flowchart of the attached figures may include multiple sub-steps or stages, which are not necessarily completed at the same time, but can be executed at different times. Their execution order is not necessarily sequential, but can be rotated or alternated with at least some of other steps or the sub-steps or stages of other steps.

It should be noted that the computer-readable medium mentioned in the present disclosure can be a computer-readable signal medium, a computer-readable storage medium, or any combination of the two. Computer readable storage media can be, for example but not limited to, systems, devices, or elements of electricity, magnetism, light, electromagnetism, infrared, or semiconductors, or any combination thereof. More specific examples of computer-readable storage media may include, but are not limited to, electrical links with one or more wires, portable computer disks, hard drives, random access memory (RAM), read-only memory (ROM), erasable programmable read-only memory (EPROM or flash memory), fiber optics, portable compact disk read-only memory (CD-ROM), optical storage devices, magnetic storage devices, or any suitable combination thereof. In the present disclosure, a computer-readable storage medium can be any tangible medium containing or storing a program that can be used by an instruction execution system, apparatus, or device, or used in combination with it. In the present disclosure, computer-readable signal media may include data signals propagated in the baseband or as part of a carrier wave, carrying computer-readable program code. This propagated data signal can take various forms, including but not limited to electromagnetic signals, optical signals, or any suitable combination thereof. Computer readable signal media can also be any computer-readable medium other than computer-readable storage media, which can transmit, propagate, or transmit programs for use by or in combination with instruction execution systems, devices, or equipment. The program code contained on a computer-readable medium can be transmitted using any suitable medium, including but not limited to: wires, optical cables, RF (radio frequency), etc., or any suitable combination of the above.

The computer-readable medium mentioned above may be included in the electronic device mentioned above, and can also exist independently without being assembled into the electronic device.

The above-mentioned computer-readable medium stores one or more programs, which, when executed by the electronic device, cause the electronic device to perform the method shown in the above embodiments.

According to one aspect of the present disclosure, there is provided a computer program product or computer program including computer instructions stored in a computer-readable storage medium. The processor of a computer device reads the computer instructions from a computer-readable storage medium, executes the computer instructions, and causes the computer device to perform the methods provided in the various optional implementations mentioned above.

Computer program code for performing the operations in the present disclosure can be written in one or more programming languages or combinations thereof, including object-oriented programming languages such as Java, Smalltalk, C++, or conventional procedural programming languages such as “C” language or similar programming languages. The program code can be completely executed on the user's computer, partially executed on the user's computer, executed as an independent software package, partially executed on the user's computer and partially executed on a remote computer, or completely executed on a remote computer or server. In cases involving remote computers, remote computers can connect to user computers through any type of network, including local area networks (LANs) or wide area networks (WANs), or can connect to external computers (such as using internet service providers to connect via the internet).

The flowchart and block diagram in the attached figures illustrate the possible implementation architecture, functions, and operations of the system, method, and computer program product according to various embodiments of the present disclosure. In this regard, each box in a flowchart or block diagram can represent a portion of a module, program segment, or instruction that contains one or more executable instructions for implementing a specified logical function. It should also be noted that in some alternative implementations, the functions indicated in the box can also occur in a different order than those indicated in the accompanying drawings. For example, two consecutive boxes can actually be executed in basic parallel, and sometimes they can also be executed in opposite order, depending on the functionality involved. It should also be noted that each box in the block diagram and/or flowchart, as well as the combination of boxes in the block diagram and/or flowchart, can be implemented using dedicated hardware based systems that perform specified functions or actions, or can be implemented using a combination of dedicated hardware and computer instructions.

The modules described in the embodiments of the present disclosure can be implemented through software or hardware. Where the name of the module does not constitute a limitation on the module itself in some cases. For example, Module A can also be described as “Module A configured to perform B operations”.

The above description is only a preferred embodiment of the present disclosure, and an explanation of the technical principles applied. Those skilled in the art should understand that the scope of the present disclosure referred to in the present disclosure is not limited to technical solutions formed by specific combinations of the above technical features, and should also cover other technical solutions formed by arbitrary combinations of the above technical features or their equivalent features without departing from the above disclosed concept. For example, a technical solution formed by replacing the above features with (but not limited to) technical features with similar functions disclosed in the present disclosure.

1. A communication method, performed by a sensing initiator, comprising:
determining that not all of sensing measurement reports from a sensing responder are received; and transmitting a first Null Data Packet Announcement (NDPA) frame, wherein the first NDPA frame indicates the sensing responder to perform a sensing measurement again and feedback a sensing measurement report.

2. The communication method according to claim 1, wherein transmitting the first NDPA frame comprises:
transmitting the first NDPA frame, wherein the first NDPA frame comprises a measurement setup identifier (MSID) and sensing parameter information, and the MSID comprises an MSID corresponding to a target Measurement Setup (MS) for which not all of the sensing measurement reports are received, and the sensing parameter information comprises sensing parameter information of the target MS.

3. The communication method according to claim 2, wherein the first NDPA frame comprises first identifier information indicating that the first NDPA frame is configured to initiate a sensing measurement again.

4. The communication method according to claim 3, wherein the sensing parameter information comprises measurement setup expiry exponent information, and in response to a time of initiating the sensing measurement again exceeding time information in the measurement setup expiry exponent information, the sensing responder is indicated to no longer perform the sensing measurement.

5. The communication method according to claim 1, wherein before determining that not all of the sensing measurement reports from the sensing responder are received, the method comprises:
transmitting a first radio frame indicating the sensing responder to transmit sensing measurement reports.

6. The communication method according to claim 5, wherein transmitting the first radio frame comprises:
in trigger-based (TB) sensing measurement, transmitting a sensing measurement report trigger frame; or
in sensing by proxy (SBP), transmitting a MS report request frame.

7. The communication method according to claim 6, wherein after in the trigger-based (TB) sensing measurement, transmitting the sensing measurement report trigger frame, the method comprises:
in response to not receiving a part or all of sensing measurement reports from one or more sensing responders, determining that not all of the sensing measurement reports are received.

8. The communication method according to claim 1, wherein transmitting the first NDPA frame comprises:
in a non-trigger-based (NTB) sensing measurement, when a manner for feedbacking the sensing measurement reports is immediate feedback, transmitting the first NDPA frame once; and when a manner for feedbacking the sensing measurement reports is delayed feedback, transmitting the first NDPA frame twice.

9. The communication method according to claim 6, wherein in the SBP, transmitting the MS report request frame comprises:
in the SBP, transmitting the MS report request frame within an SBP initiator availability window, wherein the MS report request frame comprises an MSID corresponding to a target MS for which not all of the sensing measurement reports are received and a measurement event identifier (ID) of the target MS.

10. The communication method according to claim 9, wherein the MS report request frame comprises second identifier information indicating that an SBP initiator does not receive an SBP measurement report.

11. A communication method, performed by a sensing responder, comprising:
receiving a first Null Data Packet Announcement (NDPA) frame, wherein the first NDPA frame identifies that a sensing initiator does not receive all of sensing measurement reports, and the first NDPA frame indicates the sensing responder to perform a sensing measurement again and feedback a sensing measurement report.

12. The communication method according to claim 11, wherein receiving the first NDPA frame comprises:
receiving the first NDPA frame, wherein the first NDPA frame comprises a measurement setup identifier (MSID) and sensing parameter information, and the MSID comprises an MSID corresponding to a target Measurement Setup (MS) for which not all of the sensing measurement reports are received, and the sensing parameter information comprises sensing parameter information of the target MS.

13. The communication method according to claim 12, wherein the first NDPA frame comprises first identifier information indicating that the first NDPA frame is configured to initiate a sensing measurement again.

14. The communication method according to claim 13, wherein the sensing parameter information comprises measurement setup expiry exponent information, and in response to a time of initiating the sensing measurement again exceeding time information in the measurement setup expiry exponent information, the sensing responder is indicated to no longer perform the sensing measurement.

15. The communication method according to claim 11, wherein before receiving the first NDPA frame, the method comprises:
receiving a first radio frame indicating the sensing responder to transmit the sensing measurement reports;
wherein receiving the first radio frame comprises:
in trigger-based (TB) sensing measurement, receiving a sensing measurement report trigger frame; or
in sensing by proxy (SBP), receiving a MS report request frame.

16. (canceled)

17. The communication method according to claim 16, wherein in the SBP, receiving the MS report request frame comprises:
in the SBP, receiving the MS report request frame within an SBP initiator availability window, wherein the MS report request frame comprises an MSID corresponding to a target MS for which not all of the sensing measurement reports are received and a measurement event identifier (ID) of the target MS.

18. The communication method according to claim 17, wherein the MS report request frame comprises second identifier information indicating that an SBP initiator does not receive an SBP measurement report.

19. The communication method according to claim 11, wherein receiving the first NDPA frame comprises:
in a non-trigger-based (NTB) sensing measurement, when a manner for feedbacking the sensing measurement reports is immediate feedback, receiving the first NDPA frame once; and when a manner for feedbacking the sensing measurement reports is delayed feedback, receiving the first NDPA frame twice.

20.-21. (canceled)

22. An electronic device, comprising one or more memories and one or more processors, wherein a computer program is stored in the one or more memories and executable on the one or more processors, wherein the one or more processors execute the program to implement the method according to claim 1.

23. A computer-readable storage medium, wherein a computer program is stored in the computer-readable storage medium, and one or more processors execute the computer program to implement the method according to claim 1.
